(19) United States
(12) Patent Application Publication
(10) Pub. No.: US 2024/0182098 A1
(43) Pub. Date: Jun. 6, 2024

(54) HANDLE FOR A HAND-DRIVEN LOAD MOVER

(71) Applicants: Nir ZOR, Givatayim (IL); Sapir ZOR, Givatayim (IL)

(72) Inventors: Nir ZOR, Givatayim (IL); Sapir ZOR, Givatayim (IL)

(21) Appl. No.: 18/438,479

(22) Filed: Feb. 11, 2024

Related U.S. Application Data
(63) Continuation-in-part of application No. 18/128,345, filed on Mar. 30, 2023, now Pat. No. 11,897,529.
Application No. 18/128,345 is a continuation of application No. PCT/IB2022/057932, filed on Aug. 24, 2022.
(60) Provisional application No. 63/236,242, filed on Aug. 24, 2021.

(51) Int. Cl. B62B 5/00

(52) U.S. Cl. CPC B62B 5/004

(57) ABSTRACT

A handle for a hand-driven load mover, including: an actuator; a control unit; a power source; wherein the control unit is adapted to be in communication with a controller, battery pack and motor operationally coupled to, or embedded in, a wheel of the load mover.

This is a continuation-in-part of U. S. Provisional patent application Ser. No. 18/128,345, filed Mar. 30, 2023, which is incorporated in its entirety as if fully set forth herein.

### FIELD OF THE INVENTION

The present invention relates to motorized, hand-driven vehicles and, more particularly, to a suitcase, cart, trolley, hand trucks, shopping trolley, etc. that has motorized wheels with one or more built-it motors in the wheels and with push or touch button control in the top, bottom, or sides of the handle.

### BACKGROUND OF THE INVENTION

Most motorized carts and suitcases have transmission engines with belts and gears. Gears and wheels need to be oiled. If the engine breaks, that is something that neither a 6-year-old nor a 90-year-old, nor anyone in-between that is not a trained professional can take care of. If they try, it is both time consuming and dangerous for someone who does not know what they are doing. Furthermore, the belt needs to be oiled and can tear and cause other damage. There is also a constant need for maintenance.

The common hand-driven vehicles/load-movers run on DC motors that are external motors. These motors can overheat and explode. They are very noisy and unsafe. Many individuals have been burned by hot motors. They are also very cumbersome.

There are various carts and suitcases that are controlled wirelessly, semi-autonomously or autonomously with motion sensors and/or joysticks. Regarding wireless suitcases that follow the person, these wireless suitcases can damage a person nearby, as well as other objects in their vicinity. They are also very cumbersome. Also, the touch sensors are problematic and break very quickly and the contacts often get damaged. When the touch system breaks down, a professional repair job is needed which is undesirable, as the cost of the repair is very high and includes a lot of hassle for the user. These complex systems are often very complicated with many buttons/instructions, as well as having a cumbersome and uncomfortable user experience. There are often malfunctions with the sensors.

There are suitcases and carts that are moved by a joystick. These systems and their user interface are very cumbersome, do not provide a pleasant user experience and experience a lot of glitches. Repairs need to be performed by specialized professionals if and when the systems break down. Also, when these systems malfunction, in many cases, the user cannot move the cart or suitcase at all.

### SUMMARY OF THE INVENTION

According to the present invention there is provided a handle for a hand-driven load mover, including: an actuator; a control unit; a power source; wherein the control unit is adapted to be in communication with a controller, battery pack and motor operationally coupled to, or embedded in, a wheel of the load mover.

According to further features in preferred embodiments of the invention the actuator is a rotatable grip.

According to still further features in the described preferred embodiments the actuator is operationally coupled to the motor in a wired manner. According to further features the actuator is operationally to the motor in a wireless manner. According to further features the actuator is disposed on a top surface of the handle, the top surface being the surface farthest from the load mover.

According to further features the actuator is disposed on a bottom surface of the handle, the bottom surface being closest to the load mover. According to further features the load mover includes two three-wheel formations and a motor adapted to rotate the three-wheel formations.

According to further features the handle further includes an additional motor disposed inside a second of the two wheels. According to further features the handle further includes a display disposed on an outer surface of the handle. According to further features the control unit includes an audio indicator.

According to further features the handle further includes a USB port for charging mobile devices. According to further features the handle further includes a wireless charger for wirelessly charging mobile devices.

According to further features the actuator is an electro-mechanical push-button, a touch-sensitive button, or a rotatable switch.

According to further features rotation of the grip controls a speed at which the motor moves. According to further features rotation of the grip controls a direction in which the motor moves.

### BRIEF DESCRIPTION OF THE DRAWINGS

Various embodiments are herein described, by way of example only, with reference to the accompanying drawings, wherein:

FIGS. 1A, 1B and 1C are a front perspective view, a profile view, and a back view of an exemplary hand-driven suitcase 100 according to the present invention;

FIGS. 2A, 2B and 2C are example configurations of the button (or buttons) 150 on the handle 120;

FIGS. 3A, 3B, and 3C are a front perspective view, a profile view, and a back view of an exemplary hand-driven suitcase 100 according to the present invention;

FIG. 4 is an exploded view of an example embodiment of a handle actuator 400 that can be installed in the handle of a cart or suitcase;

FIGS. 5A and 5B are views of two example embodiments of a roller handle 500;

FIG. 6A is a view of an example hand truck, dolly, trolley 600 with a roller or rotational handle 620 disposed on an extensible arm 602, where the arm is not extended;

FIG. 6B is a view of the same trolley as FIG. 6A, but with the arm 602 extended;

FIG. 7A is an isometric view of a trolley 700;

FIG. 7B rear view of the trolley 700.

### DESCRIPTION OF THE PREFERRED EMBODIMENTS

The principles and operation of a hand-driven cart or suitcase with one or more motorized wheels according to the present invention may be better understood with reference to the drawings and the accompanying description.

There is disclosed a hand-driven, wheeled cart, suitcase, trolley, dolly, freight cart, shopping trolley, etc. that is motor-powered and actuated by an actuator disposed on or in the handle. In one embodiment, the actuator is a button a push button, e.g., a bi-state, spring-loaded button that has an “on” state when depressed and an “off” state when not depressed. The button may be a “dead man's switch”, i.e., only staying depressed as long as there is pressure on the button. Alternatively, the button can have two stable states, one state depressed (even when there is no longer any pressure on the button), and a second state where the spring is expanded, and the button protrudes outwards. The button may have hybrid functionality, i.e., working as a dead man's switch, but having a locking function, where the button can be locked in the “on” position if desired.

Alternatively, the push button may be spring-loaded and pressure sensitive, i.e., the harder the button is pushed, and/or the further the button is depressed, the faster the motor turns the wheel. Consequently, as pressure is released, the speed reduced accordingly. Here too, the button may have a locking mechanism for locking the button at a desired speed without having to maintain pressure on the button.

In yet another alternative, the actuator may be a rotatable and/or movable switch, e.g., actuated/controlled by a thumb of a user. For example, the switch can be rotated (on a round handle) or pushed downwards to increase speed moving forwards and rotated/pushed upwards to increase speed moving backwards or vice versa. Similar controls can be employed for regulating speed and/or direction of travel.

In yet another alternative, the actuator may be a touch-sensitive button, where the button is either bi-state or multi-state. The speed and/or direction can be controlled with a swiping motion (e.g., of the thumb, fingers, palm, etc.) and/or pressure on the touch pad.

In embodiments, the actuator is disposed on a handle (on the top, bottom or sides of the handle). The button augments and/or automates pushing and/or pulling the cart etc. with easy effort and a light touch on (or depression of) the button, such that even a child (e.g., 6 years old or less) and an elderly person (e.g., 90 years old or more) is able to push or pull the cart etc. without effort, even when carrying a heavy load (such as about 80 kgs).

The terms cart, dolly, hand-truck, suitcase, and the like are used representatively herein but are intended to refer equally, mutatis mutandis, to each of the aforementioned wheeled vehicles as well as any other hand-driven vehicles that fit the description. The cart or suitcase (etc.) includes at least one motorized wheel which is activated/actuated by a button in the handle of cart or suitcase.

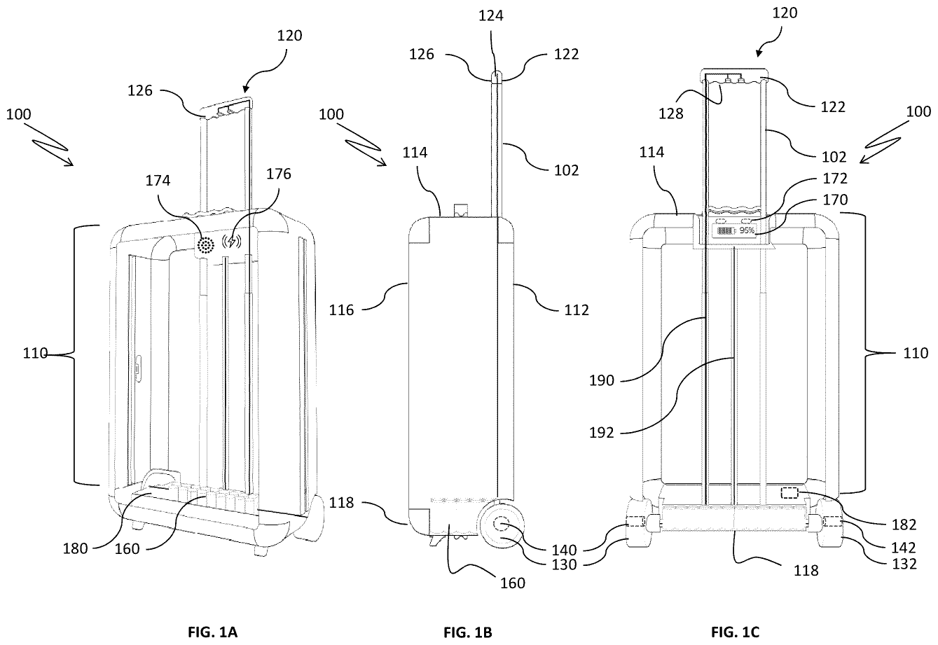

FIGS. 1A, 1B and 1C respectively illustrate a front perspective view, a profile view, and a back view of an exemplary hand-driven suitcase 100. The front perspective and back views have the front and back panels of the suitcase removed (made invisible) in order to view the internal components of the suitcase. The profile view shows the battery pack in fantom lines.

Referring to the suitcase 100 in each of the views, it is made clear that the illustrated embodiment (as well as other embodiments detailed herein) is merely exemplary and not intended to be limiting in any way.

The cart or suitcase includes a body section that has at least back, top, bottom, and front sides. For example, suitcase 100 includes a body section 110 which is adapted to house or hold the goods being transported. The body section includes a back side 112, a top side 114, a front side 116 and a bottom side 118.

The cart or suitcase includes a handle coupled to the top of the body section of the cart of suitcase. For example, suitcase 100 includes a handle 120 that is coupled to the top side 114 of the body section 110. The handle may be of any configuration that functionally serves to direct the cart or suitcase. In the exemplary embodiment depicted in the Figures, the handle 120 is disposed on extendible rods 102 that can be extended and retracted as needed. In use, the suitcase is tilted onto the [back] wheels and pulled behind the user. The handle of the cart or suitcase may be configured to pull or push (or otherwise direct) the cart or suitcase. The handle of the cart or suitcase has top, bottom, front, and back surfaces. For example, handle 120 has a back surface 122, a top surface 124, a front surface 126 and a bottom surface 128.

The cart or suitcase has at least two wheels. The two wheels are coupled to the bottom side of the body section, adjacent to the back side of the body section. For example, suitcase 100 includes two wheels 130 and 132 which are coupled to the bottom side 118 of the body section 110, adjacent to the back side 112 of the body section 118. In other embodiments, the cart or suitcase may have more than two wheels. For example, the cart or suitcase may have four wheels. A trolley may even have six or more wheels. In any of the aforementioned embodiments, at least one wheel is motorized as detailed hereafter.

The cart or suitcase according to the present invention further includes a motor (also referred to herein as an engine) housed in one of the two wheels. For example, suitcase 100 includes one wheel 130 in which a motor 140 is housed. Any type of relevant motor adapted to be housed within a wheel is to be considered within the scope of the invention. In some cases, a single motor can propel the cart or suitcase (e.g., suitcase 100) at a speed of up to approximately 10-15 kph for a distance of approximately 20 km while carrying the load of an average person, between 80-100 kg. Young children and the elderly can easily pull or push the cart or suitcase without significant effort.

The built-in motor/engine is hermetically sealed and hidden. The motor has no transmission, belt and/or gears. There are no gears that need lubrication or belts that need to be replaced when torn. The motor is built into the wheel and is very safe. There is no maintenance required. A non-functioning wheel is easily replaced. The estimated time to change a wheel with a built-in motor is about 5 minutes. There is no danger of getting burned from the built-in engine and the motor is much quieter than an external DC motor.

In some example embodiments, another (i.e., a second) motor 142 is disposed inside a second of the two wheels, e.g., in wheel 132. It may be preferable to have two built-in wheel-drives. However, the motors are sufficiently strong that if one of the motors fails, the other motor can still drive the cart/suitcase/trolley, hand-truck, dolly, freight cart, two or four wheel shopping trolley, etc.

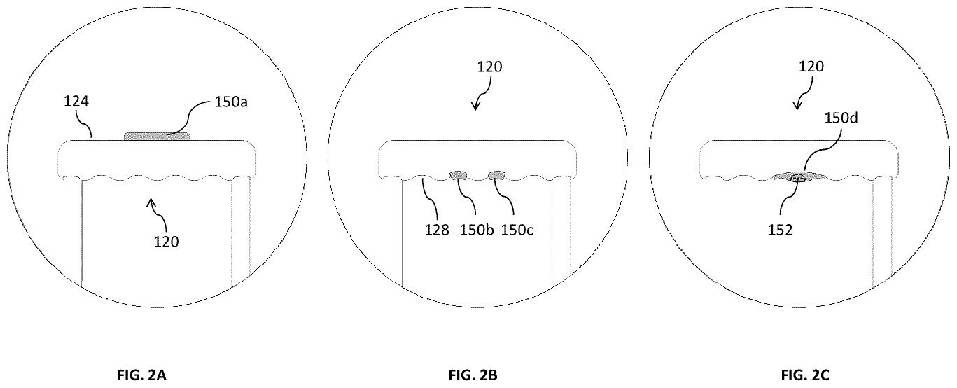

The motor is actuated/controlled by a button on the handle. For example, motor 140 is controlled (activated/actuated/deactivated/advancing in a first direction, advancing in a second direction opposite the first direction, etc.) by a button 150 (see FIGS. 2A-C). The button is disposed on handle 120.

FIGS. 2A, 2B and 2C each depict an example configuration of the button (or buttons) 150 on the handle 120. In FIG. 2A the button 150a is located on the top surface 124 of handle 120. The top surface 124 being the surface of the handle 120 that is farthest from the body section 110 of the suitcase 100 (or disposed on a plane corresponding to the plane of the top side of the body section). This button 150a may be depressed (or otherwise actuated) by the palm of the user's hand when the user is holding or gripping the handle.

In FIG. 2B, the button 150b is located on the bottom surface 128 of handle 120. The bottom surface 128 being the surface of the handle 120 that is closest to the body section 110 of the suitcase 100 (or disposed on a plane corresponding to the plane of the bottom side of the body section). The button 150b on the bottom surface of the handle may be actuated or activated by one or more fingers of the user's hand when gripping the handle.

According to some embodiments, a second button may be found on the handle of the cart or suitcase. In FIG. 2B, an example configuration is depicted including a second button 150c is disposed next to the first button 150b. In such cases, the first button 150b may be adapted to propel the wheel in a first direction while the second button 150c may be adapted to propel the wheel in a second direction, wherein the first direction (e.g., the wheel rotates in a clockwise direction) is opposite the second direction (e.g., the wheel rotates in a counterclockwise direction).

According to some embodiments, only one button is located on the bottom surface of the handle of the cart or suitcase. In FIG. 2C, an example configuration of a single button 150d is depicted. The button may be adapted to drive the motor in a specific direction (e.g., backwards). In another embodiment, the button may be adapted to drive the motor in a direction in which the suitcase or cart is being driven by the user. For example, in the embodiment of a suitcase with only two back wheels, the user tilts the suitcase back onto the wheels and pulls the suitcase backwards behind them. According to the instant embodiment, pushing the button 150d augments the user's efforts and drives the motor in the direction the user is pulling it. If the user decides to now push the suitcase forwards, the motor will reverse direction and augment the user's efforts by driving the suitcase forwards. (The directions forwards and backwards are used herein in a relative manner, relative to the front or back of the suitcase.)

In some embodiments, the button 150d may further include a rotatable switch or roller 152 (shown in phantom lines to indicate that this is an optional feature). The roller or switch being adapted to indicate the direction of travel. The section of whichever finger is on the roller/button can pull the button to the handle and also roll the roller or move the switch in the desired direction.

According to another configuration (not shown), the button is disposed on a back surface of the handle, the back surface being the surface of the handle closest to (or resting on a plane corresponding to the plane of) the back side of the body section. Such a button could be actuated by the thumb of a user, when gripping the handle. According to yet another configuration (not shown), the button is disposed on a front surface of the handle, the front surface being the surface of the handle closest to (or resting on a plane corresponding to the plane of) the front side of the body section. Such a button could be actuated by the finger (e.g., pressing down the proximal and/or intermediate phalanges) of a user, when gripping the handle.

In some embodiments, the button (or buttons) is a press/push button, i.e., an electro-mechanical button that can be physically pressed (squeezed, pushed, depressed). In other embodiments, the button (or buttons) is a touch-sensitive button. In embodiments, depressing or actuating the button pulls (or pushes) the cart or suitcase diagonally or in any other angle. It is sufficient to lightly depress the button. Such a configuration and functionality provide a much better user experience. Further, the cart or suitcase is pulled/pushed gently enough for a young child or elderly person to handle. The user can easily pull or push the suitcase, without a cumbersome interface and providing an excellent user experience.

There is disclosed a hand-driven, wheeled cart, suitcase, trolley, dolly, freight cart etc. that is motor-powered and actuated by an actuator disposed on or in the handle. In one embodiment, the actuator is a push button, e.g., a bi-state, spring-loaded button that has an “on” state when depressed and an “off” state when not depressed. The button may be a “dead man's switch”, i.e., only staying depressed as long as there is pressure on the button. Alternatively, the button can have two stable states, one state depressed (even when there is no longer any pressure on the button), and a second state where the spring is expanded, and the button protrudes outwards. The button may have hybrid functionality, i.e., working as a dead man's switch, but having a locking function, where the button can be locked in the “on” position if desired.

Alternatively, the push button may be spring-loaded and pressure sensitive, i.e., the harder the button is pushed, and/or the further the button is depressed, the faster the motor turns the wheel. Consequently, as pressure is released, the speed reduced accordingly. Here too, the button may have a locking mechanism for locking the button at a desired speed without having to maintain pressure on the button.

In yet another alternative, the actuator may be a touch-sensitive button, where the button is either bi-state or multi-state. The speed and/or direction can be controlled with a swiping motion (e.g., of the thumb, fingers, palm, etc.) and/or pressure on the touch pad.

The cart or suitcase further includes a rechargeable battery for powering the motor. For example, suitcase 100 depicted in FIGS. 1A-1C includes a rechargeable battery 160 for powering the motor 140. In example embodiments, such as shown in FIGS. 1A-1C, the battery 160 is housed proximate to the wheels 130, 132.

One example of a rechargeable battery is a 36V/4000AH battery capable of sustaining a speed 10-15 km/h for a distance of 20 km (which is a great deal of suitcase or cart travel) and able to charge a smartphone 3 times over (see below). As such, it is not necessary to charge the battery every day. In fact, the battery can probably survive the lifespan of hand-driven, load bearing vehicle, be it a suitcase, cart, trolley, or the like.

In some embodiments, the rechargeable battery 160 is a reversibly removable or detachable battery pack that is further adapted to charge various portable electronic devices, even when detached from the cart or suitcase.

In some embodiments, the cart or suitcase includes a display (e.g., a digital screen) that shows, at least, how much battery power is left. For example, suitcase 100 further includes a digital display screen 170 disposed on the back side of the body section. In other example configurations (not shown), the display is positioned at one of: the top side of the body section and the handle. The display is configured to indicate, inter alia, the remaining battery life of the battery. Such a display has an added value of providing confidence that the battery will last the journey aside from providing the practical indication whether the battery needs to be charged.

In some embodiments where the battery pack is reversibly detachable and usable in the detached state, the battery pack includes a display configured to indicate at least one of: a remaining battery life of the battery pack and an amount of battery charged afforded to the various portable electronic devices that are drawing a charge from the battery.

In some embodiments, the battery pack includes, or is operationally coupled to, an audio component 174 for indicating a status of the removeable battery pack. In some embodiments, the cart or suitcase includes one or more USB ports 172 for charging mobile devices. In some embodiments, the cart or suitcase includes a wireless charger 176 for wirelessly charging portable devices. In some embodiments, the battery is configured to wirelessly charge a wireless, touch-sensitive button (e.g., button 150).

The cart or suitcase further includes a controller for controlling, at least the motor, as well as all other electronic functions, such as, for example, the display. For example, suitcase 100 includes at least one controller 180 for controlling the motorized wheel. In the case of two motorized wheels, a single controller (e.g., a dual motor controller) 180 can control both motors 140 and 142. In other embodiments, a second controller 182 is employed for controlling, at least, the second motor 142 in the second wheel 132 of the at least two wheels of the cart or suitcase.

The cart or suitcase includes wiring that connects between the various components, including between the button(s) in the handle and the motor in the wheel. For example, suitcase 100 includes wiring 190 electrically coupling the motor(s) in the wheel(s) to the button(s) in the handle and to the battery 160. Additional wiring 192 couples the battery 160 to the display 170. Optionally, there are provided charging ports (e.g., USB ports) 172 proximate the display (or in another easily accessible location) for charging portable devices. The charging ports also derive their power from battery 160.

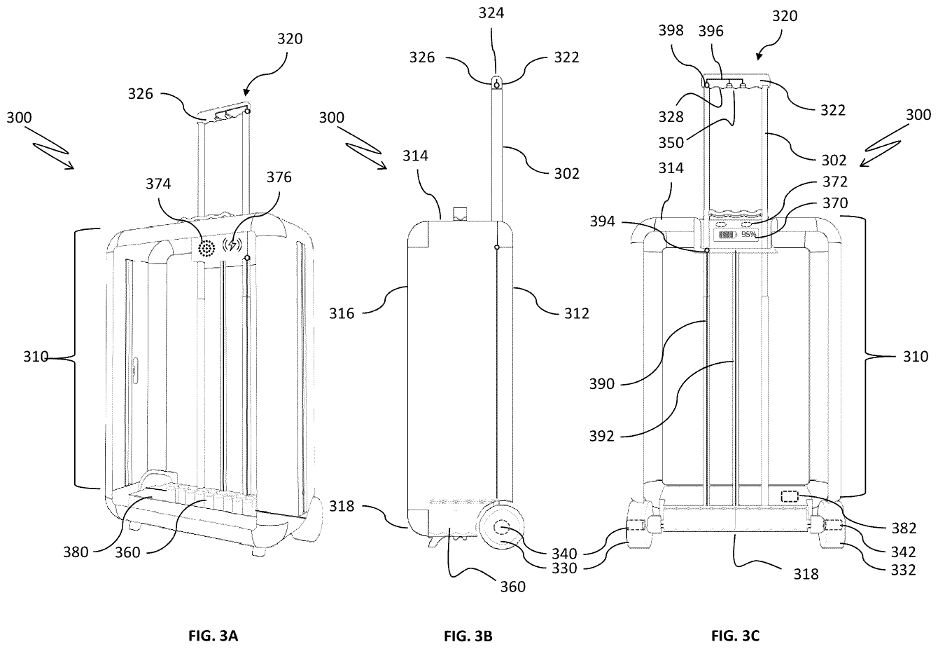

Another possible configuration is shown in FIGS. 3A, 3B, and 3C which respectively illustrate a front perspective view, a profile view, and a back view of an exemplary hand-driven suitcase 300 according to an embodiment of the present invention. FIGS. 3A-3C depict an example configuration of a suitcase 300 that is similar to suitcase 100 in every way except for the fact that a motor 340, which is housed in a wheel 330 disposed on a bottom side of a body section 310 is in wireless communication (as opposed to being either in wired or wireless communication) with a button 350 in a handle 320 which is charged only when the handle is in the retracted position. Therefore, all the details mentioned above regarding suitcase 100 should be seen as if repeated in full herein, mutatis mutandis, with the first numeral of the reference number of each component being a “3” instead of a “1”. The configurations of button or buttons depicted in FIGS. 2A-2C apply equally to the embodiment of suitcase 300, and handle 320, mutatis mutandis.

Suitcase 300 differs from suitcase 100 in that the button(s) or actuator(s) 350 is charged in a wired manner but operates (i.e., actuates the motor etc.) wirelessly. Wiring 390 extends from the battery (and is also coupled to the controller and motor) and terminates at a magnetic contact (battery side) 394. Wiring 396 in the handle begins at a magnetic contact 398 and terminates at the button or buttons 350. The handle is shown in the extended position where the handle wiring 396 is disconnected from wiring 390 in the body. When the handle is in the non-extended/retracted position, the magnetic contact (handle side) 398 magnetically couples with contact 394 and draws power for charging the button from battery pack 360.

All the configurations discussed above with regards to FIGS. 2A-2C should be seen is recited fully herein and the wiring shown here in the handle should be understood as merely one example, e.g., applicable to the configuration of FIG. 2B, and that other wiring would be used for other configurations.

For example, in some embodiments, the battery pack includes, or is operationally coupled to, an audio component 374 for indicating a status of the removeable battery pack. In some embodiments, the cart or suitcase includes one or more USB ports 372 for charging mobile devices. In some embodiments, the cart or suitcase includes a wireless charger 376 for wirelessly charging portable devices. In some embodiments, the battery is configured to wirelessly charge a wireless, touch-sensitive button (e.g., button 350).

For the sake of completeness, a list of references is provided:
300—suitcase
302—extensible rod
310—body section of suitcase
312—back side of body section
314—top side of body section
316—front side of body section
318—bottom side of body section
320—handle
322—back surface of handle
324—top surface of handle
326—front surface of handle
328—bottom surface of handle
330—wheel
323—second wheel
340—motor
342—second motor
350—button
360—battery
370—display
372—charging ports
374—audio component
376—wireless charging port
380—controller
382—second controller
390—wiring
392—additional wiring
394—magnetic contact (battery side)
396—handle wiring
398—magnetic contact (handle side)

### Additional Features/Variations

Speed of movement is set to the average speed of walking. Speed is adaptive to the speed of movement of the user. The speed is also affected by the weight of the load in the cart or suitcase.

Alternatively, or additionally, there can be preset speeds that the user can select a speed from and/or an interface via which the user sets the speed manually (e.g., turning a dial or inputting a number via an electronic interface).

Different types of handles: push handle, pull handle, telescopic, folding, rolling handle etc.

Different sizes of wheels, motors, batteries.

Automatic shut-off when not used for a predetermined amount of time.

Releasing the button stops the motor from running. In some embodiments, there is an auto-brake feature that activates when the button is released such that releasing the button stops the cart or suitcase from moving, even braking against inertia.

Each of the components is adapted for quick disassembly and/or replacement. These components include at least the battery and the motorized wheel. The disassemble and replacement can both be performed without professional knowledge in the field of electronic and/or electro-mechanics.

The system can be bought separately to the suitcase or cart and then retrofitted to the existing cart or suitcase.

The system can be scaled to any size or shape of the suitcase or cart either during manufacture or as a retrofitting set.

The mechanical parts (motor, battery, wires etc.) are insulated and well protected.

Many elderly (as well as others who walk or take public transport to shop at grocery stores) use personal shopping carts to transport their groceries from the store to home. When laden with groceries, these carts can be difficult to move around with and/or to maneuver and/or to drag up hills, especially steep hills. One especially difficult activity is hauling the cart up the stairs. The instant system is especially helpful for the elderly (as well as everyone else) and eases the activity of bumping the cart up stairs as the strong motor does most of the work. The system can even be implemented in baby strollers for all of the reasons mentioned herein.

One very good type of shopping cart (or tool cart for workmen lots of heavy tools to lug around or for dollies used for moving heavy objects and/or deliveries, such as grocery deliveries) has three wheels on each side (in a triangular formation) which helps to go up and down stairs. The motor of the instant system makes climbing stairs (as well as hauling and maneuvering the load) even easier and solves the cause of back and wrist/arm pains from dragging and pulling heavily laden carts.

The present system brings carts and suitcases into the 21^{st} century in the same way that motorized hydraulic lifts changed the ability of the workers to move and position heavy loads without expending energy and manpower.

The present system serves as a very good solution for uneven surfaces (dirt roads, uneven pavement and sidewalks) such as are often found when on vacation with heavy luggage and poor road/sidewalk/path infrastructure.

### Medical Considerations

Rolled carts and cases (including children's school cases, for example) are recognized by the medical community as one of the major causes of orthopedic problems in children and adults. Heavy loads in carts and cases exert asymmetrical weight on the body which is likely to cause back and muscle problem over time. Carts and cases which are driven (e.g., dragged behind the user) one-handed results in the burden and exerted effort being unevenly distributed throughout the body. This is often also repetitive, as most people use the same hand to pull or push a trolley, cart or suitcase. The repetitive, uneven activity causes much of the aforementioned issues.

The present system, with motorized wheel(s) that are activated by a [light] touch resulting in effortless control of even a laden cart or suitcase, was checked by medical experts and deemed to solve the aforementioned issues by lessening the strain and burden on the body considerably, such that the negative consequences of uneven distribution of weight and repetitive activities are mitigated.

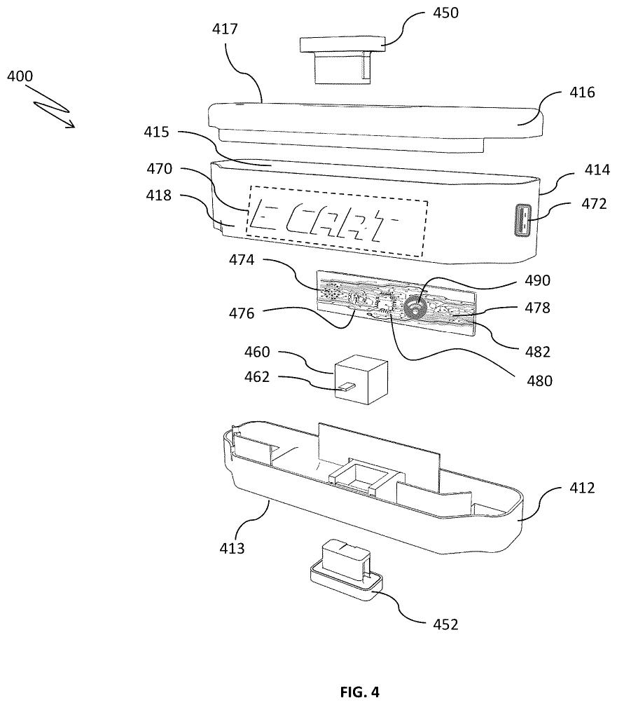

FIG. 4 illustrates an exploded view of an example embodiment of a handle actuator 400 that can be installed in the handle of a cart, suitcase etc. Handle 400 may be a “smart handle” capable of various functions and including various components. The handle actuator of FIG. 4 includes a housing that includes a bottom section 412, middle section 414, and top cover 416. In preferred embodiments, the housing of the smart handle is made from a rigid and rugged material and, when closed, the housing is waterproof or water resistant. In embodiments, the user is protected from electrical shock due to appropriate insulation. The bottom section 412 includes spaces for a battery 460 and a control unit 480. In the example embodiment depicted in FIG. 4, the battery includes a connector 462 that is adapted to connect with a charging port (not shown), for charging the battery.

In some embodiments, the battery 460 is rechargeable. In embodiments, the battery 460 is a reversibly removable or detachable battery that is further adapted to charge various portable electronic devices, even when detached from the smart handle 400. In embodiments, a standard AA or AAA rechargeable or non-rechargeable battery is used in the smart handle, instead of the depicted rechargeable battery 460. For example, the rechargeable battery 460 may be a lithium ion battery.

In some embodiments, the handle includes a display (e.g., a digital screen) that shows, at least, how much battery power is left. For example, in embodiments, handle 400 further includes a digital display screen 470 disposed on the middle section 414 (shown in broken lines to indicate that it is an optional feature). The display is configured to indicate, inter alia, a remaining battery life of the battery. Such a display has an added value of providing confidence that the battery will last the journey aside from providing the practical indication whether the battery needs to be charged.

In some embodiments the battery includes a display configured to indicate at least one of: a remaining battery life of the battery and an amount of battery charge afforded to the various portable electronic devices that are drawing a charge from the battery (e.g., via a USB charging port or a wireless charging component).

In some embodiments, the battery includes, or is operationally coupled to, an audio component 474 for indicating a status of the battery. In some embodiments, the cart or suitcase includes one or more USB ports 472 for charging mobile devices. In some embodiments, the handle includes a wireless charger 476 for wirelessly charging portable devices.

The smart handle further includes a microcontroller unit (MCU) for controlling, at least the motor, as well as all other electronic functions, such as, for example, the display. For example, smart handle 400 includes at least one MCU 480 for controlling the motorized wheel. In the case of two motorized wheels, a single controller (e.g., a dual motor controller) 480 can control both motors.

In embodiments, the smart handle includes wiring that connects between the various components, including between the button(s) in the handle and the motor in the wheel. For example, a suitcase or cart etc. includes wiring electrically coupling the motor(s) in the wheel(s) to the battery pack and to the button(s) in the smart handle 400. In embodiments, the smart handle includes a visual indicator, such as, for example, a light emitting diode LED 478. The LED may display a single color or many colors. The LED may indicate that the smart handle is active. The LED may indicate that the battery is low. The LED may indicate that the smart handle is attempting to pair with the motor, battery pack, controller (see discussion below regarding a retrofitting kit), and/or other devices/components. In embodiments, the smart handle includes one or more sensors that detect/monitor the system and audibly and/or visually indicate detected issues (e.g., low battery, fault in the motor, fault in one of the components, etc.).

In embodiments, such as the embodiment depicted in FIG. 4, the aforementioned components (e.g., audio component, wireless charger, MCU, LED, wireless component) are integrated on a printed circuit board (PCB) 482. In embodiments, the smart handle is wired. In embodiments, the smart handle 400 is wireless.

The handle/actuator 400 is versatile and can be implemented in any suitcase, cart, trolley, hand truck etc. In some embodiments, the wheeled load-bearing vessels (suitcase, trolley, etc.) can be retrofit with wheels that have built-in motors, a battery pack and wired or wireless controller that couples to the actuator 400 (or any of the actuators, handles, etc. disclosed herein). In this manner, any load-bearing vehicle can become a motorized load-bearing transportation tool.

As with the battery pack, the battery 460 can be easily removed/replaced if necessary. This is true for any of the components. For example, if the button is defective or breaks, the housing can be opened, and the button replaced. Also, the entire handle can be easily and quickly replaced if it is no longer working.

Like the battery pack, the handle battery includes an auto shut-off function to preserve the battery. In fact, any of the components, features, and/or functions that are found in the embodiments discussed above, can also be implemented, mutatis mutandis, in the smart handle.

In embodiments, the smart handle (and likewise the battery packs and systems detailed above) includes strategically placed ventilation openings to ensure that the components do not overheat. These openings, coupled with the aforementioned insulation and resilient housing, ensure that the handle is always at a temperature that is appropriate and comfortable to the touch.

The button may be any type of button or actuator. The location of the button may likewise be in any appropriate place on the handle. A button 450 is located on, or disposed in, a top surface 417 of smart handle 400. This button 450 may be depressed (or otherwise actuated) by the palm of the user's hand when the user is holding or gripping the handle.

A second button 452 is located on, or disposed in, the bottom surface 413 of handle 400. The bottom surface 413 being the surface of the handle 120 that is adapted to be closest to the suitcase, dolly, or cart etc. The button 452 on the bottom surface of the handle may be actuated or activated by one or more fingers of the user's hand when gripping the handle.

It is made clear that the example embodiment is merely one option chosen from many variations. For example, in embodiments there is only one button (top, bottom, front, or back). In other embodiments there are more than two buttons (top, bottom, front, back, compound buttons/actuators, and/or elsewhere on the handle).

According to some embodiments, a second button may be found on the smart handle 400 (see for example FIG. 2B, a second button 150c is disposed next to the first button 150b). In such cases, the first button 452 may be adapted to propel the wheel in a first direction while the second button may be adapted to propel the wheel in a second direction, wherein the first direction (e.g., the wheel rotates in a clockwise direction) is opposite the second direction (e.g., the wheel rotates in a counterclockwise direction).

According to some embodiments, only one button is located on the bottom surface of the smart handle. The button may be adapted to drive the paired motor in a specific direction (e.g., backwards). In another embodiment, the button may be adapted to drive the motor in a direction in which the suitcase or cart etc. is already being driven by the user. For example, in the embodiment of a suitcase with only two back wheels, the user tilts the suitcase back onto the wheels and pulls the suitcase backwards behind them. According to the instant embodiment, pushing the button 452 augments the user's efforts and drives the motor in the direction the user is pulling it. If the user decides to now push the suitcase forwards, the motor will reverse direction and augment the user's efforts by driving the suitcase forwards. (The directions forwards and backwards are used herein in a relative manner, relative to the front or back of the suitcase.)

In some embodiments, the button 452 may further include a rotatable switch or roller (similar to switch/roller 152 in FIG. 2C on button 150d). The roller or switch being adapted to indicate the direction of travel. The section of whichever finger is on the roller/button can pull the button to the handle and also roll the roller or move the switch in the desired direction.

According to another configuration (not shown), the button is disposed on/in a back surface/wall 415 of the middle section 414 of the housing. The back surface/wall being the surface of the handle that is adapted to be closest to (or resting on a plane corresponding to the plane of) the back side of a suitcase, trolley, cart, etc. Such a button could be actuated by the thumb of a user, when gripping the handle. According to yet another configuration (not shown), the button is disposed on/in a front surface/wall 418 of the middle section 414 of the housing. The front surface being the surface of the handle adapted to be closest to (or resting on a plane corresponding to the plane of) the front side of the body section. Such a button could be actuated by the finger (e.g., pressing down the proximal and/or intermediate phalanges) of a user, when gripping the handle.

In some embodiments, the button (or buttons) is a press/push button, i.e., an electro-mechanical button that can be physically pressed (squeezed, pushed, depressed). In other embodiments, the button (or buttons) is a touch-sensitive button. In embodiments, depressing or actuating the button pulls (or pushes) the cart or suitcase diagonally or in any other angle. It is sufficient to lightly depress the button. Such a configuration and functionality provide a much better user experience. Further, the cart or suitcase is pulled/pushed gently enough for a young child or elderly person to handle. The user can easily pull or push the suitcase, without a cumbersome interface and providing an excellent user experience.

In embodiments, the actuator is a push button, e.g., a bi-state, spring-loaded button that has an “on” state when depressed and an “off” state when not depressed. The button may be a “dead man's switch”, i.e., only staying depressed as long as there is pressure on the button. Alternatively, the button can have two stable states, one state depressed (even when there is no longer any pressure on the button), and a second state where the spring is expanded, and the button protrudes outwards. The button may have hybrid functionality, i.e., working as a dead man's switch, but having a locking function, where the button can be locked in the “on” position if desired.

Alternatively, the push button may be spring-loaded and pressure sensitive, i.e., the harder the button is pushed, and/or the further the button is depressed, the faster the motor turns the wheel. Consequently, as pressure is released, the speed reduced accordingly. Here too, the button may have a locking mechanism for locking the button at a desired speed without having to maintain pressure on the button.

In yet another alternative, the actuator may be a touch-sensitive button, where the button is either bi-state or multi-state. The speed and/or direction can be controlled with a swiping motion (e.g., of the thumb, fingers, palm, etc.) and/or pressure on the touch pad. The touch pad can alternatively, or additionally, be configured to select a speed, prior to, or during, travel.

In still other optional embodiments, the actuator may be a rotatable and/or movable switch, e.g., actuated/controlled by a thumb of a user. For example, the switch can be rotated (on a round handle) or pushed downwards to increase speed moving forwards and rotated/pushed upwards to increase speed moving backwards or vice versa. Similar controls can be employed for regulating speed and/or direction of travel.

In summary, not only is the activation of the motor controlled by the button(s)/actuator(s), but also the speed and/or direction of movement.

In embodiments, a wheeled carrier for carrying a load and/or a smart handle includes a weighing mechanism for weighing the load being carried in the carrier. The weighing mechanism may be implemented in the handle, and adapted to weigh the contents of the carrier when the carrier is lifted by the handle. In other embodiments, the weighing mechanism is disposed inside the carrier, e.g., on/in the internal floor of the carrier or on/in the load bearing surface of the carrier. Such a feature may be particularly useful for porters who move goods from place to place on the carrier, or for school bags (or school bag trolleys) to indicate the weight of the books etc. in the bag. Furthermore, school bags (or bag trolleys) often include a central telescopic arm and handle that held with fingers on either side of the place where the central arm connects to the handle. In such cases, it may be beneficial to include two buttons, such as shown in FIG. 2B.

In embodiments, there is provided a kit for retrofitting an existing hand-driven load-mover (suitcase, cart, trolley, dolly, hand-truck, etc.) with a motorized wheel or wheels and a smart handle. In example embodiments, one or more wheels of the load-mover are replaced with a motorized wheel described elsewhere herein. The kit further includes a battery pack such as described elsewhere herein. The battery pack is connectable to the motorized wheel, preferably with a plug and play, intuitive connection. In embodiments, the kit includes wiring to couple the battery pack to a handle such as smart handle 400. In other embodiments, the battery pack additionally, or alternatively, includes a wireless component that is pairable with a corresponding wireless component 490 on the smart handle.

In embodiments, instead of having a single wheel on each side of the load mover, the kit can include a three-wheel per side arrangement, an example of which is discussed elsewhere herein. The motorized three-wheel arrangement can replace a single wheel or a non-motorized three-wheel arrangement.

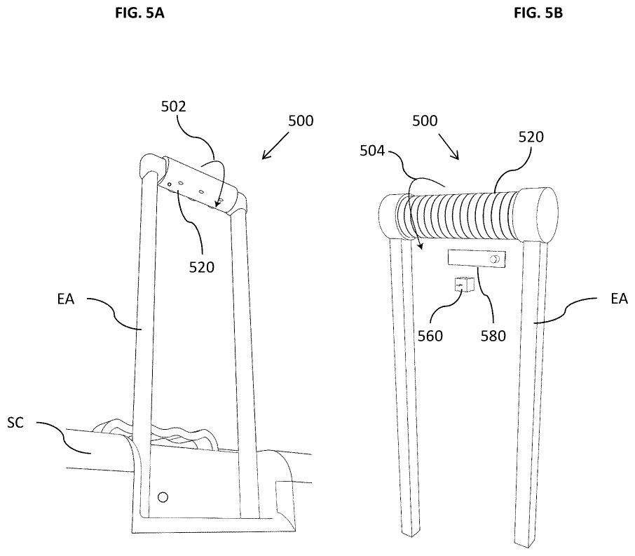

According to another configuration, there is disclosed hereafter a roller handle 500. Two example embodiments of a roller handle 500 are depicted in FIGS. 5A and 5B. FIG. 5A depicts an example roller handle 500 on a suitcase SC with an extensible arm EA. The handle includes an actuator, a control unit, and a power source, where the control unit is adapted to be in communication with a controller, battery pack, and motor operationally coupled to, or embedded in, a wheel of the load mover. In the example embodiment of FIGS. 5A and 5B, the actuator is a rotatable grip 520.

An arrow 502 indicates a direction (backwards and forwards) in which the grip can be rotated in order to activate the motor. In embodiments, the rotational movement of handle controls the direction and/or speed at which the motor moves the wheels. For example, a small rotation of the handle (e.g., 10-25 degrees of rotation) in the direction of the arrow 502 will make the suitcase move in the direction of the handle turn at a slow rate (e.g., 2-4 km/h). If the user turns the handle more, the suitcase will move faster.

FIG. 5B depicts an exploded view of a roller or rotation handle 500 disposed on an extensible arm EA as well as an example battery 560 and control unit 580. A directional arrow 504 indicates a direction of rotation that will move the connected load mover in the direction of rotation. In embodiments, as mentioned, the degree of torque applied to the handle increases the speed. The handle may be an integrated-type handle, such as handles 120 and 320 or the handle may be similar to the smart handle 400. Additionally, or alternatively, the handle can include various features and/or components selected from any of the embodiments described heretofore and/or combinations thereof.

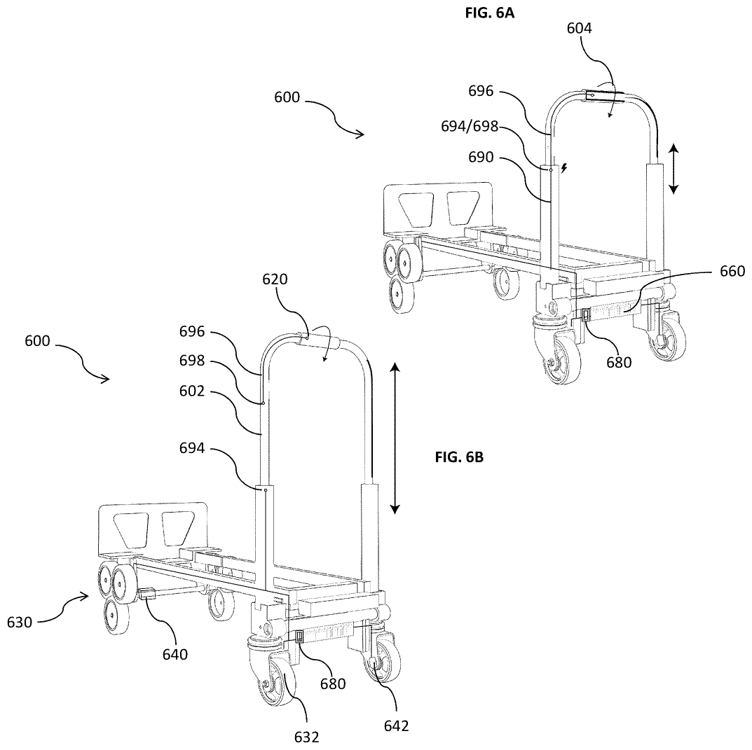

Another configuration is shown in FIGS. 6A and 6B. FIG. 6A depicts an example hand truck, dolly, trolley 600 with a roller or rotational handle 620 disposed on an extensible arm 602, where the arm is not extended. FIG. 6B depicts the same trolley as FIG. 6A, but with the arm 602 extended.

Example trolley 600 includes a feature whereby the rotational handle 620 is charged, and in some embodiments controlled, in a wired manner when the arm 602 is retracted. However, the rotational handle is adapted to function even in a wireless manner, when the arm is extended. Wiring 690 extends from the battery (and is also coupled to the controller and motor) and terminates at a magnetic contact (battery side) 694. Wiring 696 begins at a magnetic contact 698 and terminates at the handle 620. In FIG. 6B the arm 602 is shown in the extended position where the wiring 696 is disconnected from wiring 690 in the body. When the arm 602 is in the non-extended/retracted position, shown in FIG. 6A, the magnetic contact (handle side) 698 magnetically couples with contact 694 and draws power for the rechargeable battery (not shown, but similar, for example, to battery 460 or battery 560) from the battery pack 660 on the trolley 600.

Example trolley 600 has two states of use, a small-load state, and a large-load state. Trolley 600 is depicted in the large load state in FIGS. 6A and 6B. In addition, the example trolley is depicted with three wheels on each side in a triangular formation 360, which helps the trolley to go up and down stairs. When moving on a flat surface, one or two wheels are in contact with the surface. When going up or down stairs (or over uneven terrain, etc.), the formation rotates with each stair (or obstacle), climbing up or down the stairs with each rotation. One motor 640 of the instant system makes climbing stairs even easier by providing electromechanical torsion power to the rotating wheel formation 630.

Another motor 642 is built into one of the proximal wheels 632 on the handle or proximal side of the trolley. The built-in motor 642 is actuated and controlled by rotating the handle 620. This latter feature is discussed at length elsewhere herein. The rotational handle 620 may have a button or actuator for activating the distal motor 640. Alternatively, or additionally, the distal motor 640 may automatically augment the rotation of the three-wheel formation when it senses rotation of the formation. That is to say that, for example, when the motor (or a controlling unit operationally coupled to the motor) senses that the wheel formation is rotating, the motor kicks in and adds torsion/torque power to the rotating wheels. A control unit 680 is in operational communication with the battery pack 660, the motors 640 and 642. The control unit is also in operational communication with the handle 620, e.g., via wiring 690 and/or via wireless communication components in the handle and control unit. In embodiments, there is an additional motor 642 built into the second proximal wheel 632.

In the example embodiment of FIGS. 6A and 6B, the actuator is a rotatable grip 620. An arrow 604 indicates a direction (backwards and forwards) in which the grip can be rotated in order to activate the motor. In embodiments, the rotational movement of handle controls the direction and/or speed at which the motor moves the wheels. For example, a small rotation of the handle (e.g., 10-25 degrees of rotation) in the direction of the arrow 604 will make the suitcase move in the direction of the handle turn at a slow rate (e.g., 2-4 km/h). If the user turns the handle more, the suitcase will move faster.

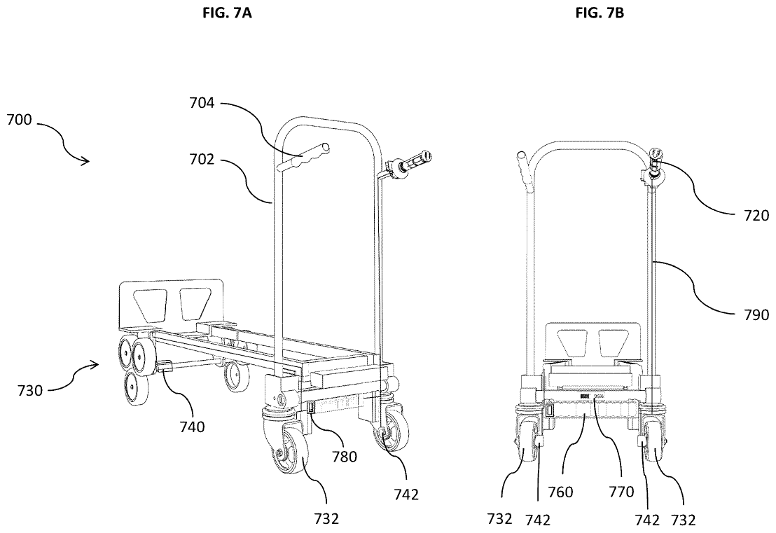

Yet another configuration is depicted in FIGS. 7A-7B. FIG. 7A illustrates an isometric view of a trolley 700 and FIG. 7B rear view of the trolley 700. Trolley 700 includes two handles which are attached to the arm 702 of the trolley. One handle, on the left-hand side, is a regular handle 704. The other handle, on the right-hand side, is a rotational handle 720. The rotational handle works in a similar fashion to the rotational handles 620 and 500, with the distinction being that the other handles are adapted to be rotated back and forth, while the instant handle 720 is adapted to be rotated clockwise and counterclockwise.

In the example embodiments, the rotational handle 720 is operationally coupled to a battery pack 760, a control unit 780, motors 740 and 742 via wiring 790. The operation and description of the components are substantially equivalent, mutatis mutandis, to the same components in the trolley 600. Trolley 700 further includes a display 770 which may display information such as, for example, battery pack charge.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks, such as controlling of the motorized movement of various folding roofs detailed above, could be implemented by hardware, by software or by firmware or by a combination thereof using an operating system.

For example, hardware for performing selected tasks according to embodiments of the invention could be implemented as a chip or a circuit. The functioning of the motorized/automated folding roof with a natural canopy may be controlled by interfacing with the chip or circuit from a local panel, and/or remotely with a remote-control device, and/or as part of a smart-house that can be controlled from anywhere by a computing device (computer, laptop, tablet, smartphone, etc.) via the Internet. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer—readable storage media with respect to the following computer-implemented methods is provided for explanatory purposes and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A handle for a hand-driven load mover, comprising:
an actuator;
a control unit;
a power source;
wherein the control unit is adapted to be in communication with a controller, battery pack and motor operationally coupled to, or embedded in, a wheel of the load mover.

2. The handle of claim 1, wherein the actuator is a rotatable grip.

3. The handle of claim 1, wherein the actuator is operationally coupled to the motor in a wired manner.

4. The handle of claim 1, wherein the actuator is operationally to the motor in a wireless manner.

5. The handle of claim 1, wherein the actuator is disposed on a top surface of the handle, the top surface being the surface farthest from the load mover.

6. The handle of claim 1, wherein the actuator is disposed on a bottom surface of the handle, the bottom surface being closest to the load mover.

7. The handle of claim 1, wherein the load mover includes two three-wheel formations and a motor adapted to rotate the three-wheel formations.

8. The handle of claim 1, further comprising:
an additional motor disposed inside a second of the two wheels.

9. The handle of claim 1, further comprising a display disposed on an outer surface of the handle.

10. The handle of claim 1, wherein the control unit includes an audio indicator.

11. The handle of claim 1, further comprising a USB port for charging mobile devices.

12. The handle of claim 1, further comprising a wireless charger for wirelessly charging mobile devices.

13. The handle of claim 1, wherein the actuator is an electro-mechanical push-button, a touch-sensitive button, or a rotatable switch.

14. The handle of claim 2, wherein rotation of the grip controls a speed at which the motor moves.

15. The handle of claim 2, wherein rotation of the grip controls a direction in which the motor moves.
